(19) United States
(12) Patent Application Publication
(10) Pub. No.: US 2010/0221692 A1
(43) Pub. Date: Sep. 2, 2010

(54) Educational Pendulum

(76) Inventors: Robert William Lally, Orchard Park, NY (US); Katherine Anne Lally, Orchard Park, NY (US)

Correspondence Address: PAUL S. PEREZ, PO BOX L, CANUTILLO, TX, 79835, US

(21) Appl. No.: 12/396,213

(22) Filed: Mar. 2, 2009

(51) Int. Cl. G09B 23/08; G01P 15/02

(52) U.S. Cl. 434/302; 73/514.36

(57) ABSTRACT

Exhibiting, exemplifying, and personifying science and technology, an adjustable, hand-held, educational pendulum instrumented with a visual inertial motion sensor resembling a lollipop consists of two hard rubber disks, a pendulum bob and a sensor mass, threaded onto a composite plastic line. Sliding the disks on the line configures the educational pendulum for various new and classical science experiments, such as oscillating naturally, changing mass of bob, changing length of arm, sensing gravity, and sensing changes in motion. Like a person, the visual inertial sensor, a mass on a spring or the pendulum equivalent, ordinarily flexes to sense changes in motion, but not that of a simple coasting swing, creating a puzzling mystery. Consciously experiencing interacting pendulum parts transferring energy push and pull on one another to rhythmically move and flex per laws of nature can help a person to better know and appreciate how transfers of energy animate and power our wonderful world.

### CROSS REFERENCE TO RELATED APPLICATIONS

Not Applicable

### STATEMENT REGARDING FEDERAL SPONSERED RESEARCH OR DEVELOPMENT

Not Applicable

### BACKGROUND OF INVENTION

Exhibiting, exemplifying, and personifying science and technology, the present invention generally relates to the fields of physics, education and demonstration, and measuring and testing. More specifically, it relates to a simple, hand-held, adjustable, educational pendulum instrumented with a visual inertial motion sensor that, like a person, ordinarily flexes to sense changes in motion, but not that of a simple coasting swing. Two disks, bob and sensor, slide on a composite plastic line to configure the educational pendulum for conducting various classical and new experiments.

Ancient wisdom encourages us to test and model all things, especially pendulums, and retain what is good. Galileo, Newton, Foucault and other famous scientists employed pendulums to explore reality. They discovered how interacting objects transferring energy push and pull on one another to move and flex per laws of nature, such as Hooke's Law of Elasticity and Newton's Laws of Motion and Gravitation. And how properties of materials, such as inertia, elasticity, friction, and gravity, which store energy in different ways, oppose moving and flexing.

The instrumented educational pendulum physically models and extends the above energy concepts. It dramatically shows that without a transfer of energy nothing happens, motion does not change, structures do not flex, and sensors do not sense.

Extending this thinking, forces involved in transfers of energy occurring in other energy realms, such as electrical, fluidic, and magnetic, also move and flex things in an analogous way.

The simple, unique, educational pendulum reflects decades of effort developing desktop educational models and pendulous, impulse-hammer calibrators. It combines classical pendulum science with modern sensing and structural dynamics technology. A simple spring-mass structure resembling a lollipop, or the pendulum equivalent, simulates both a person riding the swing and a visual inertial motion sensor, often called an accelerometer Like a person, the sensor structure ordinarily flexes to sense changes in motion, but not that of a simple coasting swing or pendulum, creating a mystery. Solving this mystery develops insight into how forces associated with transfers of energy animate and power things. Perhaps a billion or more sensors with similar structures help trigger air bags, stabilize camera images, test behavior of structures, and monitor the health of machines, among many other applications. The Internet lists over a million references to both pendulums and accelerometers.

Evidently, a pendulum naturally oscillates because the pull of gravity acting along the arcing path of the bob automatically reverses direction as the pendulum passes through vertical, creating a restoring force similar to a spring restraint. Similar resonances in structures, such as sound, noise, vibrations, and waves, often please, annoy, or destroy. Testing, modeling, and modifying the resonant behavior of structures and monitoring structural health are multi-billion dollar industries today.

Through the ages, simple man-made and nature-made objects that swing freely from a pivot have entertained, fascinated, and benefited people in many ways. Serving as a key to nature, pendulums have been used to clock time, time music, measure gravity, detect earth's rotation, sense motion, study orbiting, entertain children, and help educate future scientists and engineers. The educational pendulum exemplifies hands-on, minds-on, inquiry based learning promoted by modern teaching standards. It helps integrate the rather fragmented knowledge taught and memorized in school back into a unified whole.

### BRIEF SUMMARY OF THE INVENTION

Blending classical pendulum science with modern sensing and structural technology, the present invention is a hand-held, adjustable, educational pendulum instrumented with a visual inertial motion sensor resembling a lollipop, and an elastic-band force sensor resembling a fish scale. It simply consists of two, movable, hard rubber disks threaded onto a special compressible, flexible line suspended from a metal ring or an elastic band held in a person's hand. Sliding the moveable disks on the composite plastic line configures the structure as a simple, double, conical, or torsional pendulum. It also changes the mass of the bob and length of the suspension arm for science experiments. Plus it collapses the assembly into a compact cylinder for storage as a keychain or paperweight. Variations of the educational pendulum connect the bob and sensor disks with a separate, flexible, elastic rod, tie, or line.

The lower disk and line segment together simulate a rider and a visual inertial, motion sensor. Both ordinarily flex to sense changes in motion, but, not that of a simple coasting swing, creating a puzzling mystery to be solved.

Operating the educational pendulum involves exercising it by manually moving a pivot back and forth at a natural rate, and allowing it to coast. The natural oscillatory behavior of the educational pendulum entertains, puzzles, and enlightens people, as the energy imparted transfers back and forth from being momentarily stored as height in the earth's gravity field (potential) to motion of the bob (kinetic). Shortening the length of the suspension line increases the natural oscillating rate, but changing the mass of the bob does not affect the rate if the length of the pendulum arm is the same. Through gravity, the earth invisibly pulls on the pendulum parts as they pull on the earth, transferring energy when the pull, called weight, moves or flexes them.

Evidently during the above exercises, interacting objects, including the pendulum, earth, sensor, and operator, transferring energy push and pull on one another to move and flex per laws of nature. For example, the operator pushes on the disk or pivot; it pushes back as both move and flex, transferring energy. A bigger push or longer move transfers more energy.

Now, as always, a want and need exists for an entertaining new technical puzzle that introduces science and technology.

Therefore, the primary object of this invention is a fun, novelty item exhibiting relaxing, rhythmic motions and a motion mystery.

Another important object is a fun, physical model to help teach or learn basic force-and-motion science and technology.

Still another object is an educational model that dramatically shows how forces involved in transfers of energy flex sensor structures to sense and communicate information.

### BRIEF DESCRIPTION OF THE DRAWINGS

Two embodiments of the educational pendulum are illustrated in the following drawings, in which:

FIG, 1 is a sectioned, side view of the invention showing two cylindrical, movable, hard rubber disks threaded onto a composite, flexible, plastic line suspended from a person's hand by a key ring or elastic band.

FIG. 2 is a sectioned side view showing the structure of the flexible plastic line threaded through an undersize, central hole in the bob disk.

FIG. 3 is a sectioned view of another version of the invention showing two suspended disks spaced apart and connected by an elastic, beaded, plastic tie connected to the end of a line.

### DETAILED DESCRIPTION OF THE INVENTION

FIG. 1 illustrates an instrumented, adjustable pendulum comprising two, suspended, hard rubber, cylindrical disks, a bob disk 12 and a smaller, lighter, sensor disk 22, threaded onto a flexible, composite, plastic suspension line 32, and spaced apart near the lower end of line 32. A loop 33 tied in the upper end of line 32 connects it to a metal key ring 42 suspended by an elastic band 43 from a person's hand. A knot 34 near the lower end of line 32 positions lower disk 22 on line 32. Central undersize holes in disks 12 & 22 lightly compress and grip line 32 with friction to secure the position of the disks during use, but allow them to slide on line 32. Line 32 moves relative to disks 12 & 22 when pulled with sufficient force. The lower part 36 of line 32 and sensor disk 22 flex or tilt when bob disk 12 object experiences a change in motion.

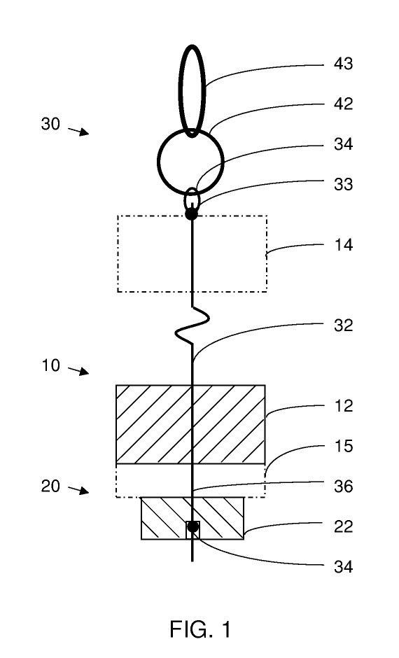

FIG. 2 illustrates the structure of composite line 32 having a stranded nylon core 38 covered with a plastic coating 37, similar to fly fishing line. Removing a section of plastic sheath 37 at one end of line 32 with an electrical, insulation stripping tool makes it easy to thread and pull line 32 through slightly undersize holes in disks 12 & 22.

Sliding moveable disks 12 & 22 on line 32 configures the structure as a simple, double, conical, or torsional pendulum. It also positions disks 12 & 22 on line 32 for various new and classical experiments.

With disks 12 & 22 positioned near each other, but some distance apart, at the lower end of line 32 as shown in FIG. 1, the mass of the sensor disk 22 and the flexible lower section 36 of line 32 between disks 12 & 22 together form a visual, inertial, motion sensor structure, called an accelerometer. The mass of sensor disk 22 is equal to or less than the mass than the bob disk 12 object, but could be bigger in size to exaggerate the flexing motion.

Viewed in the direction of arrow 20, the sensor structure, like a person, ordinarily flexes to sense changes in motion, but not that of a simple coasting swing, creating a mystery. The sensor tilts instead of flexes when the pendulum coasts. Evidently, weight due to gravity of each of the pendulum parts moves them all together as a unit, as they freely fall along the arcing path in a relaxed state tangentially. The moving pendulum and sensor parts interact with the earth, not with each other, as they move freely under the influence og gravity Without a transfer of energy from bob disk 12, the sensor does not flex to sense changes in motion.

Gravity manifested as weight powers the coasting pendulum. Through gravity, the earth pulls on the pendulum parts as they pull on the earth, transferring energy when the pull moves or flexes them. Gravity pulling on the bob and the bob pulling on line 32 stretches or contracts the visual, elastic-band 43 force sensor as the pull changes during an excursion.

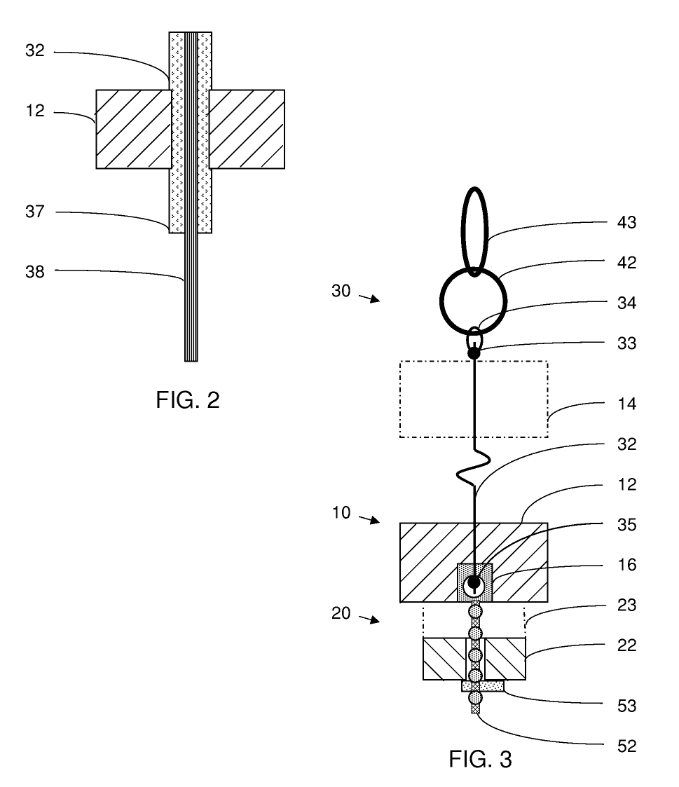

FIG. 3 illustrates another version of the educational pendulum wherein a flexible, elastic structural member 52 in the form of a beaded plastic tie or rod 52 replaces lower section 36 of line 32 connecting the two disks 12 & 22. The top end of the plastic tie 52 fitted into a mating hole 16 in bob disk 12 connects to line 32 which is threaded through central holes in disk 12 and tie 52, and is secured with knot 35. The beaded part of plastic tie 52 routes through a central hole in sensor disk 22, and is secured by a snap-on locking block. This arrangement allows bob disk 12 to be positioned anywhere along line 32, and sensor disk 22 to be positioned next to bob disk 12. The spring-mass sensor structure viewed from arrow 20 in FIG. 3 behaves the same as the pendulous line-mass sensor structure in FIG. 1, but does not flex as much for a given change in motion.

Operating the educational pendulum involves configuring it, suspending the bob assembly, manually moving a pivot at ring 42 or band 43 back and forth at a natural rate, and sensing or observing the resultant motion.

Evidently, a varying centripetal pull of line 32 on disk 12 guides the bob in an arc. Weight due to gravity acts to move the bob along the arcing path, and to further tension line 32. Pull on line 32 is greatest as it passes through vertical. Pull of gravity propelling the bob along its arcing path and the resulting change in motion is greatest at the ends of the excursion, as indicated by tilt of the sensor when the pendulum is being manually powered.

Testing behavior of the instrumented pendulum involves moving the pivot back and forth at slow, medium, and fast rates. At slow rates the bob assembly is pulled along to follow the pivot. At a medium rate the pendulum naturally oscillates, slowly building up big excursions. At a fast rate bob disk 12 remains almost still because of its inertia, while the pivot moves and the sensor wobbles to sense changes in motion.

Placing disks 12 & 22 together on line 32 forms a simple pendulum that behaves in a classical way. It swings at a preferred natural rate when coasting. Placing bob disk 12 at knot 33 and swinging from either disk 12 or 22, changes the swinging rate very little. Evidently, changing the mass of the bob does not change the natural swinging rate when the length of the pendulum arm is the same. As Newton profoundly observed, this can happen only if a change in motion (acceleration) is caused by force and opposed by mass, because adding or removing material to the bob does change both the mass (inertia) and force (weight).

Shortening the length of the pendulum arm by positioning disk 12 & 22 assembly at the mid-point of line 32 greatly increases the natural swinging rate because the restoring force on the bob due to gravity is greater for a given distance from vertical.

Conducting the above experiments, solving the motion mystery, and explaining observed pendulum behavior develops insight into how forces involved in transfers of energy animate and power the world.

Evidently, interacting educational pendulum parts transferring energy push and pull on one another and on the earth to move and flex per laws of nature. But, without an energy transfer from the swinging object, the sensor does not flex or sense. Thus, the instrumented pendulum serves as an ideal model for exhibiting energy transferring, storing, and animating things.

Such interactive transfers of energy, which are involved in all that happens, could be called eneracting, a new word. Toying with the instrumented educational pendulum encourages people to have fun naturally eneracting, and to enjoy seeing other people and things eneract.

Naturally oscillating pendulum behavior has been thoroughly tested, analyzed, and modeled by a host of dedicated scientists and technologists, including Galileo, Newton, and Foucault. Mathematical analyses referenced in Wikipedia, the open encyclopedia, show the behavior herein attributed to the instrumented educational pendulum is only approximate, and good only for small excursions, but the small deviations are not visually discernable. A tiny, pendulous, inertial motion sensor placed at the center of the educational pendulum bob would eliminate most of the secondary effects causing discrepancies.

I claim:

1. An educational pendulum comprising:
an object;
a flexible line;
a mass, equal to or less than mass of said object;
means for connecting one end of said line to said mass;
means for connecting other end of said line to a person's hand; and
moveable means for connecting said object to said line;
whereby when said object is positioned on said line near said mass and suspended by said line from said hand,
said object under the influence of gravity moves freely when said hand moves, and
said mass and the section of said line between said object and said mass together form a visual inertial motion sensor
that flexes or tilts when said object experiences a change in motion;

2. The educational pendulum of claim 1, wherein said line is a composite structure with a stranded nylon core having a plastic coating, whereby said coating compresses when routed through an undersize mating hole in said object;

3. The educational pendulum of claim 1, wherein said object and said mass are disks of hard rubber material with central holes, whereby said holes route and connect said line to said disks with friction, but allow said line to move relative to said disks when pulled with sufficient force;

4. The educational pendulum of claim 1, wherein a metal ring conndcted to said line connects said end of said line to a person's hand;

5. The educational pendulum of claim 1, wherein knots in said line position said object and said mass on said line;

6. An educational pendulum comprising
an object;
a flexible line;
a mass, equal to or less than mass said object;
an elastic structural member;
whereby said structural member connects said mass to said object suspended by said line from a person's hand,
wherein said object under the influence of gravity moves freely when said hand is moved, and
said mass and said structural member together form a visual inertial motion sensor that flexes or tilts when said object experiences a change in motion;

7. The educational pendulum of claim 6, wherein said elastic structural member is a flexible, beaded plastic rod connected to the end of said flexible line, fitted into a mating hole in said object, and routed through a central hole in said mass.
